(19) United States
(12) Patent Application Publication
(10) Pub. No.: US 2026/0150170 A1
(43) Pub. Date: May 28, 2026

(54) METHOD AND SYSTEM FOR CONTROLLING A LIGHTING SYSTEM INCLUDING A PLURALITY OF LIGHTS

(71) Applicant: LEDVANCE GmbH, Garching bei München (DE)

(72) Inventors: Wuqiang LIAO, Shenzhen Guangdong (CN); Heng LI, Shenzhen Guangdong (CN); Tao LIU, Shenzhen Guangdong (CN)

(21) Appl. No.: 19/395,596

(22) Filed: Nov. 20, 2025

(30) Foreign Application Priority Data
Nov. 25, 2024 (CN) 202411691563.X

(51) Int. Cl. H05B 47/175; G06V 20/52; G06V 40/10; G06V 40/20; H05B 47/155

(52) U.S. Cl. CPC H05B 47/1975; G06V 20/52; G06V 40/11; G06V 40/113; G06V 40/28; H05B 47/155; H05B 47/1985; H05B 47/199; G06V 2201/12

(57) ABSTRACT

A method for controlling a lighting system including a plurality of lights is provided. The lights are arranged in a physical space. The method may include providing spatial data of the physical space, detecting at least one light positioning gesture of a user, and providing visual detection data describing the at least one light positioning gesture. The method further may include positioning at least one light of the plurality of lights based, at least in part, on the visual detection data so as to provide light position data describing the position of the at least one light in the physical space. As such, selection of the at least one light for control is allowed based, at least in part, on the light position data. Furthermore, a system for controlling the lighting system is provided.

### CROSS-REFERENCE TO RELATED APPLICATIONS

This patent application claims the benefit of and priority to Chinese Patent Application No. 202411691563.X, filed on Nov. 25, 2024, which is herein incorporated by reference in its entirety.

### TECHNICAL FIELD

The present disclosure generally relates to a system for controlling lighting, and more particularly to, a method and system for controlling a lighting system including a plurality of lights.

### BACKGROUND

Lighting systems and control systems for managing known lighting arrangements, such as gesture-based lighting control systems, are generally known. However, existing gesture-based control systems exhibit several disadvantages. In particular, such systems often fail to provide precise control of individual lights or specific groups of lights within a lighting system, thereby reducing operational accuracy. Moreover, to achieve precise control, each luminaire typically must be equipped with an integrated sensor, which increases manufacturing complexity and presents challenges for inventory management.

### SUMMARY

Provided are a method and system for controlling a lighting system with a plurality of lights in some embodiments of the present disclosure. The method and system allow a user to control the lights in a precise, reliable, and user-friendly manner.

According to a first aspect, a method for controlling a lighting system with a plurality of lights is provided. The plurality of lights is arranged in a physical space. The method may be performed by a system for controlling the lighting system as described below.

The physical space may be any physical space or physical environment where lights or lights can be provided. The physical environment may be an indoor or outdoor area, a building, a portion of a building, a production facility, an office, or a residential space where lights may be arranged. In this context, a light may refer to any light, particularly a controllable light or luminaire.

The method includes providing spatial data of the physical space. The spatial data may include geometric data describing the physical space. In a non-limiting embodiment, providing the spatial data may comprise retrieving pre-stored data and/or perceiving the physical space using one or more sensors, such as visual cameras, and providing sensor or camera data describing the physical space.

The method further includes detecting at least one light positioning gesture of a user and providing visual detection data describing the at least one light positioning gesture. In a non-limiting embodiment, the system may include a visual detection module configured to capture an activity area of the user. The lights are not necessarily arranged within the detection range, as in at least some implementations described below, the system enables identification of lights even outside the field-of-view of the visual detection module.

The method further includes positioning at least one light of the plurality of lights based, at least in part, on the visual detection data, to provide light position data describing a position of the at least one light in the physical space. As used herein, “positioning a light or luminaire” means providing information about the positioning, location, and/or orientation of the light in the physical space.

Subsequently, it is possible to select at least one light for control based, at least in part, on the light position data.

In a non-limiting embodiment, the steps of detecting the positioning gesture and positioning at least one light of the plurality of lights may be performed during an initial or set up phase of system initialization.

Due to the position of the lights based on visual detection data, lights can be precisely selected, enabling precise control of the selected light or group of lights.

The method further may include detecting a light selection gesture of the user and selecting one or more lights from the plurality of lights based, at least in part, on the light selection gesture. By detecting the light selection gesture, the method enables the user to select specific lights, a single group or a plurality of groups of lights, thereby allowing precise operations to be performed on a single light or a group of lights.

The method further may include detecting a light control gesture of the user and controlling the selected one or more lights based, at least in part, on the detected light control gesture. In a non-limiting embodiment, the system may include a gesture identification module configured to identify both the light selection gesture for selecting one or more lights from the plurality of lights and the light control gesture for controlling the selected lights. In a non-limiting embodiment, when the user points at a specific location, the system can identify the light or luminaire based on previously performed light positioning and enable gesture control of the selected light.

Thus, the method achieves a fully gesture-controlled lighting system. Specifically, compared to traditional light control methods, the user is free from using an application or physical devices, knobs, or switches to control the lights.

In a non-limiting embodiment, detecting at least one light positioning gesture may include detecting at least one pointing gesture by the user toward one or more lights. The visual detection data describes at least one pointing direction of the at least one pointing gesture. The pointing direction of the user's pointing gesture can be used to calculate the position of the corresponding light in the physical space, particularly during the setup phase of initializing the system.

The method may include dividing the physical space into a plurality of zones, and the positioning at least one light may include matching at least one light of the plurality of lights to at least one of the plurality of zones. In a non-limiting embodiment, the user may point at a light, which can be captured by the visual detection module and interpreted by the device-space binding module and the device search module to position the light.

Thus, the system can detect zones, regions, or blocks within the field-of-view, estimate the direction or three-dimensional (3D) position of the light, and bind the block, direction, and/or position to the corresponding light. Binding may include binding the position, angle, and/or spatial orientation of the luminaire, enabling the user to subsequently select the luminaire by pointing at the specific device and control the luminaire through control gestures.

In a non-limiting embodiment, the device-space binding module and the device search module can be configured to map the direction or 3D position of a light to a specific zone or block within the physical space, thereby enabling the assignment or mapping of the plurality of lights to a plurality of zones of the physical space.

In a non-limiting embodiment, the mapping of a plurality of lights to a plurality of zones can be performed automatically by the control unit or manually via a user interface that displays the physical environment with the plurality of lights and the plurality of zones. In some embodiments, the mapping can be performed semi-automatically, particularly by first automatically assigning the plurality of lights to a plurality of zones, with the assignment being manually adjusted by the user if necessary.

In a non-limiting embodiment, the method may include pointing at a grid and manually binding the grid to a light from the system (e.g., from the system library). This ensures that the specifications of the lights correspond to those of the corresponding lights in the real physical space.

In some embodiments, the method includes pointing at the same light or luminaire multiple times from different angles to calculate the position of the light in the physical space. In a non-limiting embodiment, the visual detection module can be configured to provide visual detection data associated with pointing at the same light to calculate the three-dimensional coordinates of the light in the physical space.

The method may further include performing an authentication step to enable a user control of, in particular, the control system and/or the lighting system. The authentication step may include facial and/or posture identification so that the system can only be operated by authorized personnel.

According to a second aspect, a system is provided for controlling a lighting system including a plurality of lights in a physical space.

The system includes a visual detection module configured to detect at least one light positioning gesture of a user and for providing visual detection data describing the at least one light positioning gesture. In particular, one or more sensors (e.g., visual cameras) or other devices with spatial vision capabilities can be used to provide the visual detection data.

The system further includes a device-space binding module and a device search module configured to position at least one light of the plurality of lights in the physical space based, at least in part, on the visual detection data. In a non-limiting embodiment, the device-space binding module and the device search module may include a device-space binding module and a device search module as separate functional modules. The device-space binding module and the device search module may be configured as a logical module at least partially integrated into a microcontroller unit (MCU), which links the visual detection data to the actual positions of the lights, creating a spatial mapping between the camera's view and the lights.

The system further includes a gesture identification module configured to identify a light selection gesture for selecting one or more lights of the plurality of lights and a light control gesture for controlling the selected one or more lights. The gesture identification module may be configured as a logical component at least partially embedded in the MCU. In a non-limiting embodiment, the gesture identification module may be configured to detect gestures via one or more cameras and convert these gestures into lighting control commands.

The system further includes a lighting control module configured to control the selected one or more lights. In particular, the lighting control module may be configured to control the lights, for example via pulse width modulation (PWM), based on one or more communication protocols such as ZigBee, Bluetooth low energy (BLE), Wi-Fi, DALI, 2.4 GHz wireless, power line communication (PLC), KNX, etc. Bluetooth is a registered trademark of Bluetooth SIG. ZigBee is a registered trademark of the ZigBee Alliance. Wi-Fi is a registered trademark of the Wi-Fi Alliance. Digital Addressable Lighting Interface (DALI) is a registered trademark of the Digital Illumination Interface Alliance. KNX is a registered trademark of the KNX Association.

In some embodiments, the system includes an authentication module configured to perform an authentication step for enabling a user control of the system and/or lights, such as gesture-based control of the lights. The authentication module may be configured as a logic module within an MCU that stores facial and body feature data to verify whether the same person is interacting with the system.

In the following description, details are provided to describe embodiments of the present specification. However, it will be apparent to those skilled in the art that the embodiments may be practiced without these details.

Some portions of the embodiments have similar parts. Similar parts may have the same name or similar numerals. Where appropriate, the description of one part applies by reference to another similar part, thereby reducing textual repetition without limiting the disclosure.

### BRIEF DESCRIPTION OF THE DRAWINGS

FIG. 1 illustrates a schematic block diagram of a system for controlling a lighting system according to an embodiment of the present disclosure.

FIG. 2 illustrates a grid mode for processing lights of the lighting system, according to an embodiment of the present disclosure.

FIG. 3 illustrates a calibration mode for processing lights of the lighting system, according to an embodiment of the present disclosure.

FIG. 4 illustrates a visual detection mode for operating lights of the lighting system, according to an embodiment of the present disclosure.

FIG. 5 shows some exemplary control gestures applicable for controlling lights of the lighting system according to an embodiment of the present disclosure.

FIG. 6 shows a flowchart of a method for controlling lights of the lighting system according to an embodiment of the present disclosure.

### DETAILED DESCRIPTION

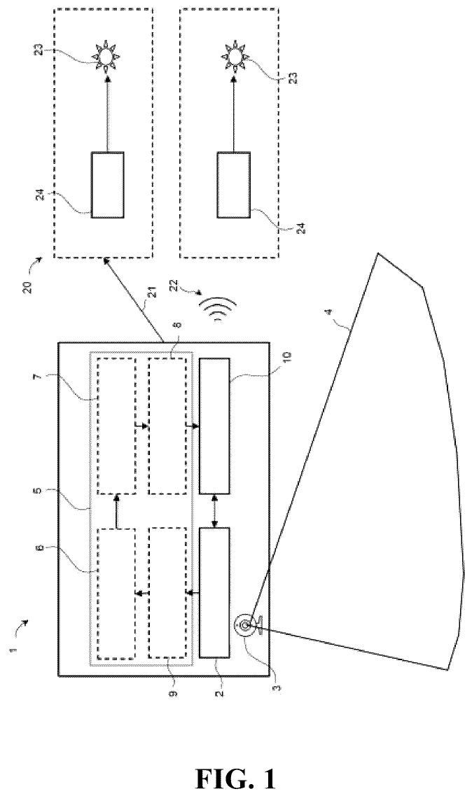

FIG. 1 illustrates a schematic block diagram of a control system 1 for controlling a lighting system 20 according to an embodiment of the present disclosure. System 1 includes a visual detection module 2, which is functionally connected to a sensor system 3 (e.g., one or more visual cameras) for visually capturing a detection area 4. System 1 further includes a control unit 5. In this embodiment, control unit 5 includes a device-space binding module 6, a device search module 7, a gesture identification module 8, and an authentication module 9. System 1 further includes a lighting control module 10 for controlling lights 23 of the lighting system 20.

On the right side of FIG. 1, a possible embodiment of the lighting system 20 is shown. In a non-limiting embodiment, lighting system 20 and system 1 may be physically connected via wired communication 21 and/or electromagnetically connected via a wireless communication path 22. However, it shall be noted that system 1 and method 100 described herein are not limited to any specific lighting system, communication method, or communication protocol.

Lighting system 20 may include any number (e.g., from one to N) of lights 23, particularly controllable lights 23 or gateways. According to one embodiment, lighting system 20 may include embedded and/or standalone lights 23 and/or gateways.

In some embodiments, lighting system 20 comprises one or more control units 24 that are communicatively connected to lights 23 and/or gateways. Lighting system 20 may include one or more interfaces configured to communicate with system 1 via wired connection means (e.g., in accordance with PWM, DALI, and/or KNX) and/or wireless connection means (e.g., in accordance with ZigBee, BLE, and/or long range (LoRa) communication protocols).

Sensor system 3 may include one or more standard visual cameras, infrared cameras, time-of-flight (ToF) sensors, or other devices with spatial vision capabilities. In some embodiments, sensor system 3 incorporates multiple sensors, such that the data from the sensors are fused to achieve composite 3D detection. Vision detection module 2 is operatively connected to sensor system 3 to receive raw image input data for subsequent data processing, such as for motion identification and verification.

As further shown in FIG. 1, sensor system 3 is configured to monitor a detection area 4. Detection area 4 does not necessarily include lights 23 but should at least partially cover a user operation area or activity zone within which user activities are detectable, such as hand movements and gestures performed by a user 50.

Upon detecting a user 50 within detection area 4, sensor system 3 generates visual data for identifying user 50 and detecting user gestures, such as user 50's positioning and control gestures.

Device-space binding module 6 is configured to bind the spatial vector relationship between the camera field-of-view 40 or detection area 4 of sensor system 3 and lights 23 during system setup or a calibration phase. Thus, device-space binding module 6 links vision detection module 2 to the actual positions of lights 23. This spatial vector relationship is adaptable to changes, such as when lights 23 are moved, removed, or added.

System 1 may operate in different modes for handling lights 23, including those outside the camera's field-of-view 40. When operated in a first mode or grid mode, the current screen's field-of-view 40 is segmented into an n×m grid. A user 50 is allowed to point at a grid 40 cell and bind that grid 40 cell to a particular light 23 in lighting system 20.

When operated in a second mode or calibration mode, user 50 points at the same light 23 multiple times from different angles, enabling system 1 to calculate the 3D coordinates of that light 23. This method typically employs machine learning to capture user 50's pointing angles (including finger and elbow angles), as well as the z-axis distance.

These two modes, namely the grid mode and the calibration mode, do not require lights 23 to be within visual detection area 4.

When operated in a third mode or visual detection mode, system 1 automatically identifies lights 23 within the camera's field-of-view 40 and highlights them and allows user 50 to bind the detected lights 23 to system 1.

Authentication module 9 may be optional and may be provided as a part of control unit 5 or as a separate module.

Gesture identification module 8 is configured to utilize sensor system 3 (e.g., such as one or more cameras) to detect user gestures and translate those gestures into corresponding lighting control actions.

Thus, by employing device-space binding module 6 and device search module 7, system 1 can detect and select a light 23 pointed-to by user 50, enabling gesture control of that specific light 23. In some implementations, user 50 also may select a group of lights 23 via a gesture for group control. User 50 further may employ a gesture to select all devices, for example, for a broadcast operation.

For security, authentication module 9 may be configured to identify users, for example, through a user library stored in the cloud or locally (i.e., in a local database) containing images, such as user images. The local database may reside within the application or on the device, stored in the device's internal memory or external memory, such as a secure digital (SD) card.

Based on known facial and body feature data, system 1 verifies user identity. A typical identification method is facial identification, such as using the vector distance of facial feature points to verify identity. In particular, body features can serve as additional markers to enhance identification accuracy. Only authenticated users are authorized to access system 1's gesture control functionality.

Lighting control module 10 can be configured to support wired and/or wireless control methods. It can be configured to manage the entire lighting system 20 by controlling individual lights 23 via PWM and/or connections to internal or external gateways. Lighting control module 10 can be configured to support multiple protocols, including but not limited to DALI, ZigBee, and Bluetooth.

For complex systems, lighting control module 10 can be configured to function as an internal gateway or a bridge to an external gateway, which allows control of the entire lighting system 20 through the external gateway. In a non-limiting embodiment, lighting control module 10 may utilize a ZigBee gateway to allow users to selectively control one or more lights 23 of the entire lighting system 20. For simpler lighting installations, lighting control module 10 can be directly connected to lights 23 via wired and/or wireless connections or control them through wired and/or wireless protocol modules.

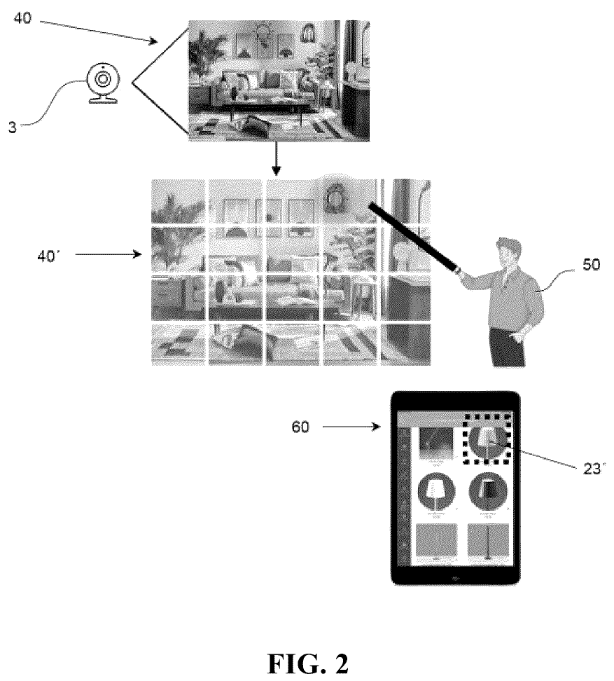

FIG. 2 illustrates a grid mode for operating lights 23 in a lighting system 20, according to an embodiment of the present disclosure. FIG. 2 schematically shows a sensor system 3 capturing a field-of-view 40. Once captured, field-of-view 40 is segmented into a grid 40′, which, in this embodiment, is a 4×5 grid. In a non-limiting embodiment, the segmentation of field-of-view 40 into a grid 40′ may be performed by device-space binding module 6, as discussed above. A user 50 can point at a grid 40′ cell (schematically represented by solid lines), once the segmentation of field-of-view 40 into a grid 40′ is done. After (or while) user 50 points to a grid 40′ cell (e.g., grid 40′ cell as shown in FIG. 2), they can manually bind grid 40′ cell to a light 23 from lighting system 20, particularly from the system library. For example, this can be accomplished by selecting and marking a corresponding light icon 23′ on a user interface 60 during the system setup phase.

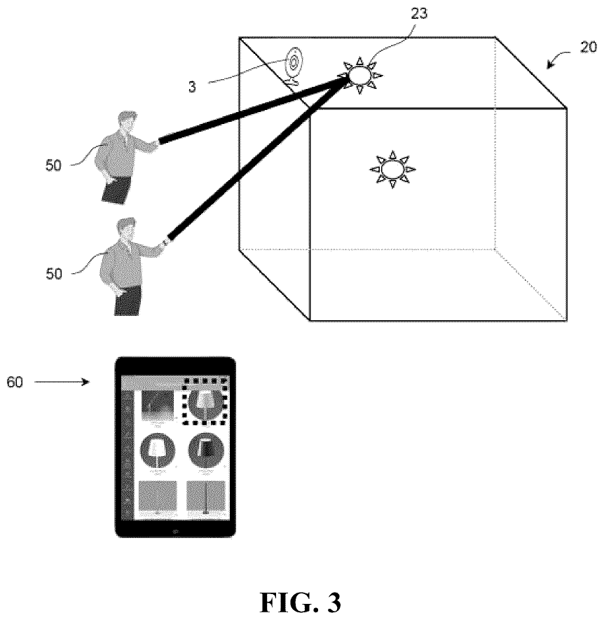

FIG. 3 illustrates a calibration mode for operating lights 23 in a lighting system 20 according to an embodiment where user 50 points multiple times at one light 23 in lighting system 20 from different positions (i.e., from different angles). Sensor system 3 captures the pointing operations of user 50, and visual detection module 2 provides visual detection data. System 1 calculates the 3D coordinates of light 23 using the visual detection data and, based on angular differences resulting from pointing at the same light 23 from different positions, binds the 3D coordinates to the corresponding light 23 in lighting system 20. Thus, the calibration mode achieves the mapping of that light 23 to its corresponding location in physical space. Similar to the grid mode, user 50 can select the corresponding light specification by choosing and marking the respective light icon 23′ on user interface 60.

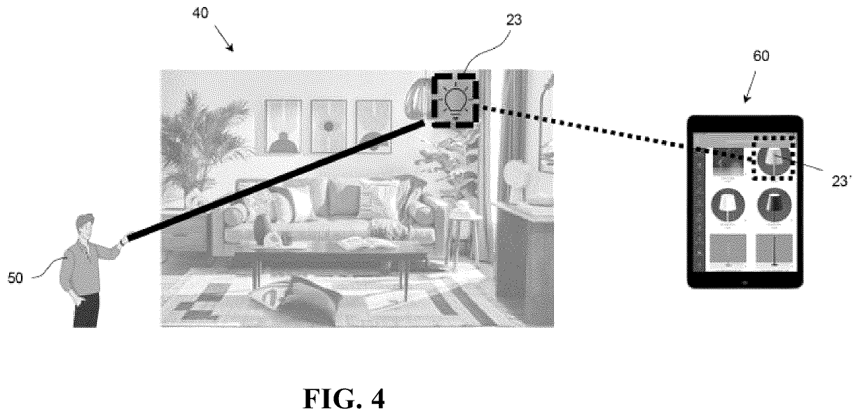

FIG. 4 illustrates a visual detection mode for operating lights 23 in lighting system 20. Specifically, FIG. 4 shows field-of-view 40 and user 50 pointing toward a light 23. In the visual detection mode, artificial intelligence (AI) vision may be utilized to detect lights 23 within field-of-view 40 and determine a light 23 pointed-to by user 50. In a non-limiting embodiment, the digital data provided by sensor system 3 can be analyzed based on an AI algorithm, which may be executed by device-space binding module 6 and/or device search module 7. User 50 then can bind light 23, and system 1 can operate based on the detected light 23 pointed-to by user 50. It should be noted that this method is applicable only when that light 23 is within the visual detection range. Depending on the binding method used, subsequent user operations involving “pointing to select a device” may require adjustments to light 23 position and/or light 23 binding to ensure accuracy and consistency.

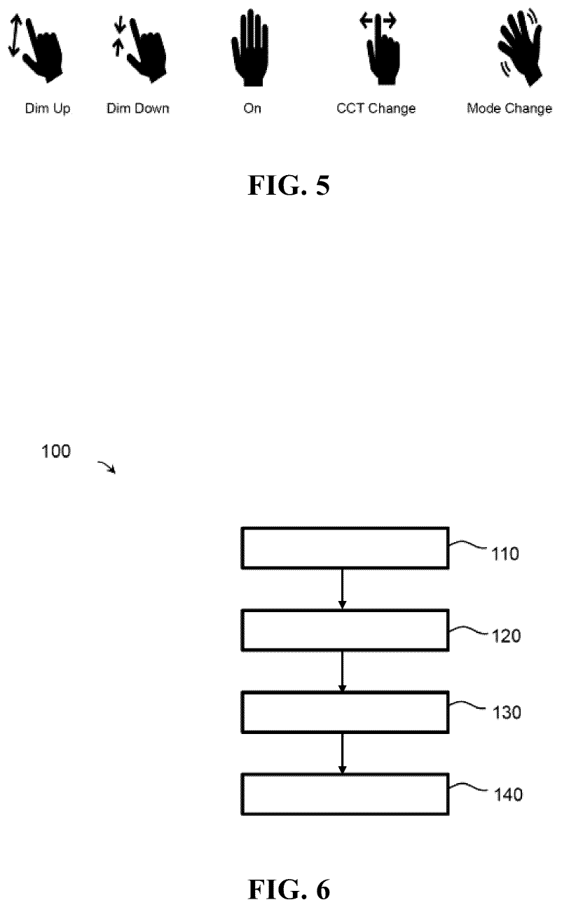

FIG. 5 illustrates some example control gestures that can be used to control lights 23 in lighting system 20 according to an embodiment of the present disclosure. Control gestures may include dynamic gestures, such as drawing a circle clockwise or counterclockwise, moving fingers, etc. Dynamic gestures are represented by arrows or wavy lines in FIG. 5. Separating or bringing together the thumb and index finger can be interpreted as commands to brighten or dim the light, respectively, as shown in the two leftmost gestures in FIG. 5. Moving the index finger sideways or waving the palm can be interpreted as commands to change the correlated color temperature (CCT) or lighting mode of a light 23, as shown in the two rightmost gestures in FIG. 5. Gestures also may include static gestures, such as clenching a fist to turn off a light 23 or opening the palm to turn it on, as shown in the center of FIG. 5.

In some embodiments, users 50 can customize the mapping between gestures and lighting controls. Additionally, users 50 can record custom gestures and map them to lighting operations through system 1. System 1 (particularly control unit 5) may be configured to integrate arm movements to enhance gesture identification accuracy.

FIG. 6 illustrates a flowchart of a control method 100 for controlling lights 23 of a lighting system 20 according to an embodiment of the present disclosure. Method 100 can be particularly performed by system 1 for controlling a lighting system 20 with lights 23 arranged in a physical space, as described above with reference to FIG. 1.

Method 100 includes providing, at step 110, spatial data of the physical space. The provided spatial data may include retrieving pre-stored spatial or geometric data describing the physical space. The providing spatial data at step 110 further may include capturing the physical space through one or more sensors and providing sensor data describing the physical space.

Method 100 further includes detecting, at step 120, at least one light positioning gesture of a user 50, and providing, at step 130, visual detection data describing the at least one light positioning gesture of user 50. In a non-limiting embodiment, at step 120, at least one pointing gesture may be detected, and visual detection data may be provided to describe at least one pointing direction of the at least one pointing gesture.

Method 100 further includes positioning, at step 140, at least one light 23 of the plurality of lights based, at least in part, on the visual detection data. In a non-limiting embodiment, at step 140, light 23 may be located in the physical space based, at least in part, on the visual detection data. In a non-limiting embodiment, the positioning may include determining 3D coordinates of light 23 in the physical space. In a non-limiting embodiment, the detection of the positioning gesture and positioning at least one light 23 of the plurality of lights may be performed during an initial or setup phase of system initialization.

Method 100 further may include dividing the physical space into a plurality of zones. The positioning of the at least one light 23 at step 140 may include matching at least one light 23 of the plurality of lights 23 to at least one zone of the plurality of zones.

In some embodiments, method 100 includes segmenting field-of-view 40 of the physical space into a grid 40′ including grid 40′ cells, pointing at a grid 40′ cell, and manually binding that grid 40′ cell with a light 23 from a lighting system 20 (e.g., a system library that may contain many different lights 23).

The at least one positioning gesture may include pointing toward the same light 23 multiple times from different angles to calculate the position of that light 23 in the physical space. In a non-limiting embodiment, visual detection data describing pointing toward the same light 23 may be used to calculate the 3D coordinates of that light 23 in the physical space.

In some embodiments, method 100 includes an authentication step for enabling light control. The authentication step may include facial and/or posture identification so that system 1 can be operated only by authorized personnel. In some embodiments, a specific predefined gesture is used to activate the control.

Steps 110 to 140 may be performed during a setup phase, particularly by a user 50, service personnel, and/or system installer.

In some embodiments, method 100 further includes detecting a user's light selection gesture and selecting one or more lights 23 from the plurality of lights 23 based, at least in part, on the light selection gesture (e.g., pointing at one or more lights 23 from the plurality of lights 23).

Method 100 further may include detecting a user's light control gesture and controlling the selected one or more lights 23 based, at least in part, on the detected light control gesture.

Thus, at steps 110 to 140, once system 1 is initialized, end user 50 is able to easily control lights 23 by selecting specific lights 23 based, at least in part, on light position data, enabling precise control of selected lights 23.

In some embodiments, user 50 is capable of pointing at multiple lights 23, particularly within a set time window, for simultaneous control of multiple lights 23. Additionally, specific gestures can be defined to trigger group control of all lights 23 within a group of lights 23 or selected lights 23. In some embodiments, a light 23 being pointed-at may blink to confirm that light 23 is being pointed-at and/or being selected.

Thus, a system 1 and method 100 are provided for controlling a lighting system 20 in a particularly precise and user-friendly manner. Users 50 can directly point at and control individual lights 23 or a group of lights 23, ensuring precise operation.

Furthermore, no additional hardware such as ultra-wideband (UWB) wearable devices (e.g., smartwatches) is required to assist with lighting control.

Method 100 is also particularly hygienic, as the contactless control approach prevents contamination, enhancing cleanliness and convenience.

Since gestures are customizable, users 50 can create and map custom gestures for flexible and convenient control.

To implement method 100, lights 23 of lighting system 20 do not require any specialized sensors, thereby reducing hardware costs.

Moreover, system 1 is easily scalable, for example, for building complex systems where it supports both simple and complicated lighting installations, including gateway bridging.

Method 100 enables versatile and user-friendly gesture control of lighting systems 20. In some implementations, system 1 for controlling a lighting system 20 (e.g., a courtyard lighting system) is configured such that users 50 can trigger gesture control only when directly pointing at a specific light 23, thereby significantly reducing the likelihood of accidental or unintended activation.

Furthermore, the methods and systems described herein are broadly compatible with all standard protocols, such as ZigBee, DALI, Bluetooth, etc., and are applicable to most lighting systems 20 without requiring special support from lights 23.

While at least one exemplary embodiment has been presented in the foregoing detailed description, it should be appreciated that a vast number of variations exist. It should also be understood that such exemplary embodiments are merely examples, and are not intended to limit the scope, applicability, or configuration of the disclosure in any way. Rather, the foregoing detailed description will provide those skilled in the art with a convenient road map for implementing one or more exemplary embodiments.

### List of Reference Numerals

1 System
2 Visual Detection Module
3 Sensor System
4 Detection Area
5 Control Unit
6 Device-Space Binding Module
7 Device Search Module
8 Gesture Identification Module
9 Authentication Module
10 Lighting Control Module
20 Lighting System
21 Wired Communication
22 Wireless Communication Path
23 Light
23′ Light Icon
24 Control Unit
40 Field-of-View
40′ Grid
50 User
60 User Interface
100 Method for Controlling a Lighting System
110 Providing Spatial Data of the Physical Space
120 Detecting at least one Light Positioning Gesture
130 Providing Visual Detection Data
140 Positioning at least one Light of the Plurality of Lights

What is claimed is:

1. A method for controlling a lighting system comprising a plurality of lights arranged in a physical space, the method comprising:
providing spatial data of the physical space;
detecting at least one light positioning gesture of a user;
providing visual detection data describing the at least one light positioning gesture; and
positioning at least one light of the plurality of lights based, at least in part, on the visual detection data so as to provide light position data describing a position of the at least one light in the physical space, thereby enabling selection of the at least one light for control based, at least in part, on the light position data.

2. The method according to claim 1, further comprising:
detecting a light selection gesture of the user; and
selecting at least one light from the plurality of lights based, at least in part, on the light selection gesture.

3. The method according to claim 2, further comprising:
detecting a light control gesture of the user; and
controlling the selected at least one light based, at least in part, on the detected light control gesture.

4. The method according to claim 1, wherein detecting the at least one light positioning gesture comprises:
detecting at least one pointing gesture of the user pointing toward the at least one light, wherein the visual detection data describes at least one pointing direction of the at least one pointing gesture.

5. The method according to claim 1, wherein:
the method further comprises:
dividing the physical space into a plurality of zones; and
positioning the at least one light comprises:
matching the at least one light of the plurality of lights to at least one zone of the plurality of zones.

6. The method according to claim 1, further comprising:
segmenting a field-of-view of the physical space into a grid having a plurality of grid cells;
pointing at a grid cell of the plurality of grid cells; and
manually binding the grid cell to at least one light of the plurality of lights from the lighting system.

7. The method according to claim 1, wherein the at least one positioning gesture comprises pointing multiple times toward the at least one light from different angles for calculating the position of the at least one light in the physical space.

8. The method according to claim 1, further comprising:
performing an authentication step for enabling a user control.

9. A system for controlling a lighting system comprising a plurality of lights arranged in a physical space, the system comprising:
a visual detection module configured to:
detect at least one light positioning gesture of a user; and
provide visual detection data describing the at least one light positioning gesture;
a device-space binding module and a device search module configured to position at least one light of the plurality of lights in the physical space based, at least in part, on the visual detection data;
a gesture identification module configured to identify:
a light selection gesture for selecting at least one light of the plurality of lights; and
a light control gesture for controlling the selected at least one light; and
a lighting control module configured to control the selected at least one light.

10. The system according to claim 9, further comprising an authentication module configured to perform an authentication step for enabling a user control.
